(19) United States
(12) Patent Application Publication
(10) Pub. No.: US 2024/0369008 A1
(43) Pub. Date: Nov. 7, 2024

(54) METHOD FOR HEATING AN EXHAUST GAS SENSOR

(71) Applicant: Robert Bosch GmbH, Stuttgart (DE)

(72) Inventor: Andreas Schwaerzle, Stuttgart (DE)

(21) Appl. No.: 18/714,767

(22) PCT Filed: Nov. 21, 2022
(86) PCT No.: PCT/EP2022/082561

§ 371 Date: May 30, 2024

(30) Foreign Application Priority Data
Dec. 22, 2021 (DE) 10 2021 214 880.8

(51) Int. Cl. F01N 11/00; H05B 1/02

(52) U.S. Cl. CPC F01N 11/00; H05B 1/0236; F01N 2560/025; F01N 2560/026; F01N 2560/05; F01N 2560/20

(57) ABSTRACT

A method for heating an exhaust gas sensor, wherein the exhaust gas sensor comprises at least one heating element. The method comprises: a) providing an energy model of the exhaust gas sensor, wherein the energy model describes an energy input via an effective heater voltage of the heating element and a heater resistance of the heating element; b) determining an energy threshold; c) continuously calculating the energy input by means of the energy model, resulting in a calculated energy input; and d) heating the exhaust gas sensor by means of the heating element until the calculated energy input reaches the energy threshold.

### BACKGROUND INFORMATION

In order to comply with applicable exhaust gas provisions, the use of various exhaust gas sensors for exhaust gas aftertreatment is generally essential for modern internal combustion engines. Nitrogen oxide (NOₓ) sensors, particulate sensors, wideband lambda probes, and binary lambda probes are commonly used, the latter generally being used only in gasoline engines or gas engines. For example, a lambda signal from the wideband lambda probe serves to meter an amount of fuel, improve an exhaust gas aftertreatment, and monitor a three-way catalyst efficiency. The nitrogen oxide sensors can generally be used to ascertain a nitrogen oxide concentration and/or an oxygen concentration in the exhaust gas. When using SCR catalysts, an ammonia concentration can additionally be determined. In nitrogen oxide storage catalysts, a loading or an end of a storage possibility is thereby generally detected, whereas accurate metering of a urea-water solution generally takes place in SCR catalysts.

The mentioned exhaust gas sensors are generally provided with heating elements in order to ensure the respective functionality. The heating element of the particulate sensor is generally used to regenerate a sensor element of the particulate sensor, soot being burnt off by heating in the regeneration. Here, the heating element is generally only operated in an unsteady state. The further sensors generally only function at a sufficiently high working temperature of a sensor ceramics and are therefore generally continuously heated to a specified target temperature.

The heating phase of the sensors is generally specified on the basis of a heating profile in the form of a voltage curve defined in the technical customer documentation. Since a voltage supply, which usually corresponds to the onboard power system voltage, typically cannot be controlled, a desired effective voltage is generally ensured by a heater final stage by means of a duty cycle.

In order to ensure that the sensor is protected from overheating, a maximum heating time is generally defined. If a valid temperature signal is not available, the probe heater must generally be switched off after the end of this time or must be switched to a safe operating mode with significantly reduced effective heater voltage. A specified maximum time generally takes into account a manufacturing variation of the heater resistance as well as critical ambient conditions in a specified heater ramp and is typically designed for a battery voltage above 12 V. However, the actually required heating time of the sensor may vary significantly therefrom, for example due to low ambient temperatures, long overrun phases, and reduced battery voltage. Further influencing factors may, for example, be an installation position of the sensor, a residual moisture, and water in the exhaust tract.

It is generally known how the heating process is to be adjusted in the case of a reduced battery voltage. In this case, a heating time is specified depending on the battery voltage, wherein the heating time with t˜U² is approximately proportional to the square of the voltage. Further influencing variables on the actual sensor temperature are generally neglected in the heating phase.

Some diagnostics of a heated exhaust gas sensor can generally only be carried out robustly when the probe is very warm or hot. In order to make this possible, a release of the diagnostics on the basis of an energy model is generally carried out in individual cases.

### SUMMARY

Provided according to the present invention are a method for heating an exhaust gas sensor, a system comprising at least one exhaust gas sensor and at least one controller, a computer program, and a data carrier, which at least largely avoid the above-described disadvantages of conventional devices and methods. In particular, faster heating of the exhaust gas sensor under variable boundary conditions and ambient conditions and taking into account the component protection is to be made possible.

An exhaust gas sensor in the sense of the present invention is generally to be understood to mean any device configured to detect at least one measured variable of an exhaust gas, for example a physical and/or a chemical measured variable, in particular an optical and/or an electrical measured variable. For example, the exhaust gas may be an exhaust gas of an internal combustion engine, in particular in the automotive area. The exhaust gas sensor can in particular be configured to generate at least one sensor signal, in particular at least one electrical sensor signal, for example an analog and/or digital sensor signal.

The exhaust gas sensor can in particular be selected from the group consisting of: a nitrogen oxide sensor; a particulate sensor; a lambda probe, in particular a wideband lambda probe; a binary lambda probe. Other embodiments are also generally possible.

The exhaust gas sensor can in particular comprise at least one heating element. The heating element can in particular be configured to heat at least one component of the exhaust gas sensor.

In particular, the exhaust gas sensor can be a particulate sensor and the heating element can be configured for regenerating the exhaust gas sensor, particulates, in particular soot, being burnt off by a heating process in the regeneration. In this case, the heating element can in particular be operated in an unsteady state. The particulate sensor can in particular have an integrated temperature measuring element with a measurement range of −40° C. to 950° C., in particular in order to make accurate control of the regeneration possible.

Further exhaust gas sensors generally function only at a sufficiently high working temperature of a ceramic element of the exhaust gas sensor and are therefore generally continuously heated to a specified target temperature.

In the case of nitrogen oxide sensors and lambda probes, on the other hand, the temperature of the ceramic element is generally ascertained via an internal resistance of the ceramic element. The internal resistance can generally only be measured from an increased temperature, depending on the respective ceramic element and a used evaluation logic, in particular an analog circuit or an ASIC.

In a first aspect of the present invention, a method for heating an exhaust gas sensor is provided.

According to an example embodiment of the present invention, the method comprises the steps listed below. The method may comprise further steps not mentioned. The steps can in particular be performed sequentially and at least partially repeatedly.

The method comprises the following steps:
a) providing an energy model of the exhaust gas sensor, wherein the energy model describes an energy input via an effective heater voltage of the heating element and a heater resistance of the heating element;
b) determining an energy threshold;
c) continuously calculating the energy input by means of the energy model, resulting in a calculated energy input; and
d) heating the exhaust gas sensor by means of the heating element until the calculated energy input reaches the energy threshold.

The method can in particular be a computer-implemented method. The term “computer-implemented” may in particular relate to a process that is completely or partially implemented using data processing means, in particular using at least one processor.

As stated above, in step a), the energy model is provided. The energy model can describe a heating state of the exhaust gas sensor. The energy model can be based on an energy balance of the exhaust gas sensor.

According to an example embodiment of the present invention, by means of the energy model, the energy input can be ascertained via the effective heater voltage of the heating element and the heater resistance of the heating element. The effective heater voltage can in particular be or comprise a battery voltage of a battery of the heating element. The effective heater voltage can be changed by means of a duty cycle. A duty cycle in the context of the present invention is to be understood to mean the ratio of a pulse duration to a pulse period duration. The duty cycle is given as a dimensionless ratio with a value of 0 to 1 or 0% to 100%. By varying the duty cycle, the arithmetic average of the effective heater voltage can be changed, for example. The effective heater voltage can in particular be calculated from a product of heater voltage and duty cycle.

According to an example embodiment of the present invention, the energy model can furthermore take into account at least one parameter selected from the group consisting of: a convective energy exchange between an exhaust gas, a ceramic element of the exhaust gas sensor, and/or a housing of the exhaust gas sensor; a conductive energy exchange between the ceramic element of the exhaust gas sensor and the housing of the exhaust gas sensor; a conductive energy exchange between the housing of the exhaust gas sensor and an external environment of the exhaust gas sensor; a thermal radiation between the ceramic element of the exhaust gas sensor and the housing of the exhaust gas sensor; a thermal radiation between the ceramic element of the exhaust gas sensor and a protective tube of the exhaust gas sensor. Other parameters are also generally possible. During the heating phase, the convective energy exchange, the conductive energy exchange, and the thermal radiation typically have an effect in the form of heat losses at the probe ceramics and, where appropriate, can also be taken into account as a flat power loss. Energy losses, which are used for an energy balance, can likewise be specified as a function of the modeled energy or as a constant value.

As stated above, in step b), the energy threshold is determined on the basis of the energy model. The term “energy threshold” generally refers to an energy that must be supplied to a physical system in order to trigger a particular reaction. The energy threshold can be ascertained, in particular in a real operation of the exhaust gas sensor, by means of a WPA model, and in particular under unfavorable ambient conditions. In particular, the energy threshold can be ascertained by means of the WPA model during a cold start. Furthermore, the energy threshold can be ascertained by means of the WPA model in cold ambient conditions. Furthermore, the energy threshold can be determined by means of a BP model. The BP (best performance) model is generally a defect-free system. The defect-free system can have a lowest specified resistance of the heater, in particular according to a manufacturing tolerance.

According to an example embodiment of the present invention, the energy threshold can in particular be selected such that a temperature target corridor is achieved with the energy threshold. The temperature target corridor can be determined by limit probes. The WPA model can be used to determine a lower temperature, and the BP model can be used to determine an upper temperature.

The term “cold start” generally refers to starting a non-preheated motor vehicle. In particular, any and all, in particular all, components of the motor vehicle can have an identical temperature level during the start. In particular, any and all, in particular all, temperature sensors of the motor vehicle can have an identical temperature level. In particular, the lambda probe can have a temperature of less than 50° C. during a cold start.

The WPA (worst case acceptable) model can in particular be a defect-free system that has aged, i.e., it is barely able to comply with the exhaust gas limit values. This can in particular be a motor vehicle at the end of its service life. An aged system is generally also used to take all required detection measurements in a fault system for approval by an authority. The WPA model can in particular take into account a borderline high heater resistance of the heating element.

As stated above, in step c), the energy input is continuously calculated via an effective heater voltage of the heating element and the heater resistance of the heating element. The term “continuously calculating” in the context of the present invention is to be understood to mean that the energy input is calculated as soon as an electronic control unit (ECU) is operational and software is executed. Specific switch-on conditions and/or boundary conditions that are additionally taken into account can be omitted. There are thus no specific switch-on conditions and/or boundary conditions.

The method steps a) to d) can be carried out by means of a computer program when the latter is running on a computer or computer network, wherein step c) is started as soon as the computer program is in operation, i.e., as soon as the computer program is running. Furthermore, step c) can be carried out in a time span in which operation of the heating element would be possible. However, the heating element does not have to be in operation.

As stated above, in step d), the exhaust gas sensor is heated by means of the heating element until the energy input reaches the energy threshold. This results in a variable heating time. The term “heating time” generally refers to a time span that is required to heat an element to a desired temperature.

An exemplary calculation is shown below:

An effective heater voltage U_{h,eff} (in volts) is calculated from the product of the heater voltage Uₕ (in volts) and the duty cycle DC.

$${U}_{h , eff} = DC \cdot {U}_{h} \qquad ( 1 )$$

The heater current Iₕ (in amperes) is calculated from the heater voltage Uₕ (in volts) and the heater resistance Rₕ (in ohms).

$${I}_{h} = \frac{{U}_{h}}{{R}_{h}} \qquad ( 2 )$$

The heating power P is calculated from the product of the effective heater voltage U_{h,eff} (in volts) and the heater current Iₕ (in amperes).

$$P = {U}_{h , eff} \cdot {I}_{h} = \frac{DC \cdot {U}_{h}^{2}}{{R}_{h}} \qquad ( 3 )$$

The energy E (in joules) of the exhaust gas sensor is calculated from the following time integral, wherein Pₕ corresponds to the heating power (in watts) and Pₕₗₒₛₛ corresponds to a flat power loss (in watts).

$$E = {\int }^{t} ( {P}_{h} - {P}_{hloss} ) \qquad ( 4 )$$

Typical values at a target temperature can be:
Uₕ=12V
Rₕ=5 ohms
DC=0.2
Pₕₗₒₛₛ=Pₕ=5.76 W

Pₕₗₒₛₛ and Pₕ are equated assuming an energetic equilibrium.

In a further aspect of the present invention, a system comprising at least one exhaust gas sensor and at least one controller is provided. The controller comprises at least one processor. The controller is configured to carry out the method steps according to the method according to the present invention as described above or as described below.

In a further aspect of the present invention, a computer program is provided, which is configured, when it is running on a computer or computer network, to carry out the method according to the present invention as described above or as described below.

In a further aspect of the present invention, a computer program with program code means is provided. The computer program is configured to carry out the method according to the present invention as described above or as described below when the program is executed on a computer or computer network.

In a further aspect of the present invention, a data carrier on which a data structure is stored is provided. The data structure is configured, after it is loaded into a working memory and/or main memory of a computer or computer network, to perform the method according to the present invention as described above or as described below.

In a further aspect of the present invention, a computer program product with program code means stored on a machine-readable carrier is proposed for performing the method as described above or as described below when the program is executed on a computer or computer network.

In this respect, a computer program product is understood to mean the program as a commercial product. It can generally be available in any form, for example on paper or a computer-readable data carrier and can in particular be distributed via a data transmission network. In particular, the program code means can be stored on a computer-readable data carrier and/or a computer-readable storage medium. The terms “computer-readable data carrier” and “computer-readable storage medium” as used here can relate in particular to non-transitory data memories, for example a hardware data storage medium on which computer-executable instructions are stored. The computer-readable data carrier or the computer-readable storage medium can in particular be or comprise a storage medium such as a random access memory (RAM) and/or a read-only memory (ROM).

In a further aspect of the present invention, a modulated data signal is provided, wherein the modulated data signal comprises instructions, executable by a computer system or computer network, for performing a method as described above or as described below.

The method according to the present invention and the devices according to the present invention have numerous advantages over conventional methods and devices. In particular, faster heating of the probe under variable boundary conditions and ambient conditions and taking into account the component protection can be made possible.

The basis is generally an energy model of the exhaust gas sensor, which model describes the heating state and can be used for a diagnostics release. While the battery voltage is generally, at most, taken into account in the conventional heating methods, the energy modeling is in particular based on an energy balance of the sensor element. By suitably specifying an energy threshold or temperature threshold in the energy model, a permitted heating time can be flexibly adjusted to the ambient conditions, and safe transition into the controlled operation can be made possible.

In addition to the mentioned advantages, the present invention generally significantly reduces application costs. Fewer parameters are also generally required, which generally reduces the memory requirement of software. The model-based approach generally describes a heating duration as a function of a plurality of influencing parameters, which, according to the current related art, due to the multi-dimensional solution space, would generally not be able to be represented via direct consideration by means of the application.

The heating state of a heated exhaust gas sensor can be ascertained via an energy balance. Depending on the selected state variable (energy or temperature), the following influencing variables (not conclusive) can in particular be taken into account: energy input as a function of a heater resistance; convective energy exchange between exhaust gas and a ceramic element of the exhaust gas sensor, in particular a probe ceramics, and a housing of the exhaust gas sensor, in particular a probe housing; conductive energy exchange between the ceramic element of the exhaust gas sensor, in particular the probe ceramics, and the housing of the exhaust gas sensor, in particular the probe housing, and between the housing of the exhaust gas sensor, in particular the probe housing, and an environment; a thermal radiation between the ceramic element of the exhaust gas sensor, in particular the probe ceramics, and the housing of the exhaust gas sensor, in particular the probe housing, or a protective tube.

During the heating phase, the convective energy exchange, the conductive energy exchange, and the thermal radiation typically have an effect in the form of heat losses at the probe ceramics and, where appropriate, can also be taken into account as a flat power loss. A curve of an effective heater voltage in the heating phase is generally specified by the manufacturer, taking into account permitted tensile stresses. A heating duration, which is to be designed to be variable in particular via the application, can now generally be implemented via a simple specification of a suitable modeled energy threshold or temperature threshold. Up to the specified threshold, the exhaust gas sensor can generally be operated at a maximum permitted effective heater voltage, and a fastest possible and safe transition to the controlled operation can generally be implemented.

### BRIEF DESCRIPTION OF THE DRAWING

Other optional details and features of the present invention emerge from the following description of preferred embodiment examples, which are shown schematically in the figure.

FIG. 1 shows an exploded view of a wideband lambda probe.

### DETAILED DESCRIPTION OF EXAMPLE EMBODIMENTS

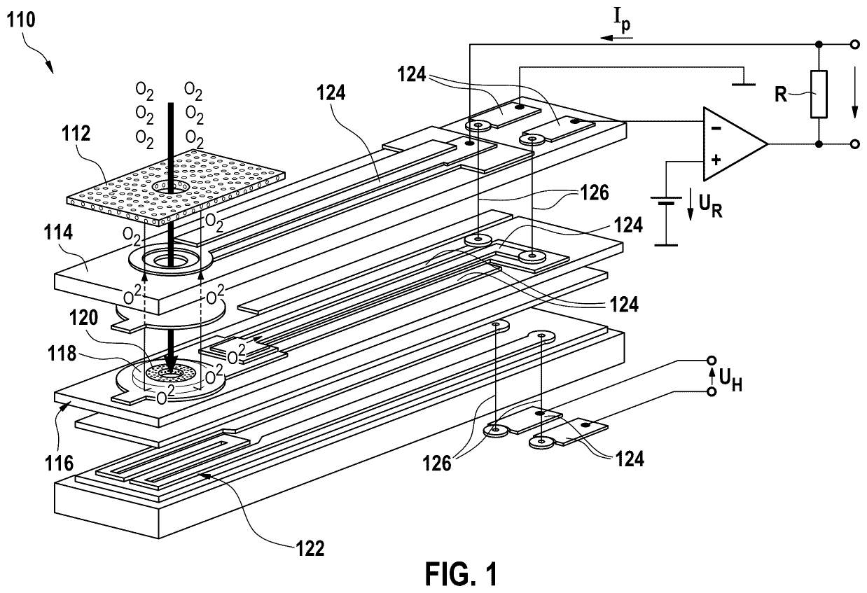

FIG. 1 shows an exploded drawing of a wideband lambda probe 110. The wideband lambda probe 110 can comprise pump cell 114 with a porous protection layer 112. Furthermore, the wideband lambda probe 110 can comprise a Nernst cell 116. FIG. 1 shows a cavity 118 and a diffusion barrier 120. Furthermore, the wideband lambda probe 110 can comprise a heating element 122. The wideband lambda probe 110 can comprise a plurality of platinum electrodes 124. Electrically conductive connections are shown schematically in FIG. 1 with lines 126. In FIG. 1, I_{P} denotes a pump current, U_{R} denotes a reference voltage, U_{H} denotes a heating voltage, and R denotes an electrical resistance.

1-10. (canceled)

11. A method for heating an exhaust gas sensor, wherein the exhaust gas sensor includes at least one heating element, wherein the method comprises the following steps:
a) providing an energy model of the exhaust gas sensor, wherein the energy model describes an energy input via an effective heater voltage of the heating element and a heater resistance of the heating element;
b) determining an energy threshold;
c) continuously calculating the energy input using the energy model, resulting in a calculated energy input; and
d) heating the exhaust gas sensor using the heating element until the calculated energy input reaches the energy threshold.

12. The method according to claim 11, wherein the method is a computer-implemented method.

13. The method according to claim 11, wherein steps a) to d) are carried out using a computer program when the computer program is running on a computer or computer network, wherein step c) is started as soon as the computer program is in operation.

14. The method according to claim 11, wherein the energy model takes into account at least one parameter selected from a group including: (i) a convective energy exchange between an exhaust gas, and a ceramic element of the exhaust gas sensor, and/or a housing of the exhaust gas sensor; (ii) a conductive energy exchange between the ceramic element of the exhaust gas sensor and the housing of the exhaust gas sensor; (iii) a conductive energy exchange between the housing of the exhaust gas sensor and an external environment of the exhaust gas sensor; (iv) a thermal radiation between the ceramic element of the exhaust gas sensor and the housing of the exhaust gas sensor; (v) a thermal radiation between the ceramic element of the exhaust gas sensor and a protective tube of the exhaust gas sensor.

15. The method according to claim 11, wherein, in step d), the exhaust gas sensor is heated with a maximum permitted effective heater voltage of the heating element.

16. The method according to claim 11, wherein, after step d), the heating element is operated in a controlled manner.

17. A system, comprising:
at least one exhaust gas sensor including at least one heating element; and
at least one controller including at least one processor, wherein the controller is configured to:
a) provide an energy model of the exhaust gas sensor, wherein the energy model describes an energy input via an effective heater voltage of the heating element and a heater resistance of the heating element;
b) determine an energy threshold;
c) continuously calculate the energy input using the energy model, resulting in a calculated energy input; and
d) heat the exhaust gas sensor using the heating element until the calculated energy input reaches the energy threshold.

18. The system according to claim 17, wherein the exhaust gas sensor is selected from a group including: a nitrogen oxide sensor; a particulate sensor; a lambda probe, a wideband lambda probe; a binary lambda probe.

19. A non-transitory data carrier on which a data structure is stored, the data structure being configured for heating an exhaust gas sensor, wherein the exhaust gas sensor includes at least one heating element, the data structure, after it is loaded into a working memory and/or main memory of a computer or computer network, causing the computer or computer network to perform the following steps:
a) providing an energy model of the exhaust gas sensor, wherein the energy model describes an energy input via an effective heater voltage of the heating clement and a heater resistance of the heating element;
b) determining an energy threshold;
c) continuously calculating the energy input using the energy model, resulting in a calculated energy input; and
d) heating the exhaust gas sensor using the heating clement until the calculated energy input reaches the energy threshold.
